(19) United States
(12) Patent Application Publication
(10) Pub. No.: US 2006/0065720 A1
(43) Pub. Date: Mar. 30, 2006

(54) Service execution device, service execution method and charging system

(75) Inventors: Takayuki Asako, Ebina-shi (JP); Hitoshi Tsushima, Ebina-shi (JP); Yasuyuki Shimizu, Ebina-shi (JP); Kenji Tsutsumi, Ebina-shi (JP); Takashi Hirata, Ebina-shi (JP); Takuya Honda, Ebina-shi (JP); Yukimasa Ishida, Ebina-shi (JP); Hiroshi Yamamoto, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/075,271

(22) Filed: Mar. 9, 2005

(30) Foreign Application Priority Data
Sep. 24, 2004 (JP) 2004-278136

(51) Int. Cl. G06K 5/00; G06K 7/01

(52) U.S. Cl. 235/382; 235/382.5

(57) ABSTRACT

A service execution device which includes a user identification information memory, an account identification information memory, a service execution section and an aggregation section. The user identification information memory stores user identification information for identifying users. The account identification information memory stores account identification information, which is associated with the user identification information and identifies accounts. The service execution section executes services in accordance with instructions from users for whom account identification information corresponding to user identification information is present and who are identified by this user identification information. The services are processes relating to document data. The aggregation section aggregates results of execution by the service execution section for each account of the account identification information.

### CROSS-REFERENCE TO RELATED APPLICATION

This application claims priority under 35 USC 119 from Japanese Patent Application No. 2004-278136, the disclosure of which is incorporated by reference herein.

### BACKGROUND OF THE INVENTION

1. Field of the Invention

The present invention relates to a service execution device and method and to a charging system, and more particularly relates to a service execution device, service execution method and charging system for charging for services which apply processing relating to documents.

2. Description of the Related Art

There are technologies which relate to distributed processing systems, in which programs and services (functions) distributed over a network are linked and processing sequences are executed. A network linking apparatus is known as such a distributed processing system. When functions and programs which operate on various devices connected to a network are to be combined for linked processing corresponding to individual users and usage methods, the network linking apparatus propagates linked processing data between the various linked devices in accordance with a processing sequence.

In such a system, if limitations on usage are specified for user IDs (user identification numbers) corresponding to users, when a user uses a service, the user can be identified and usage can be limited.

However, when introduction of a charging mechanism to such a system has been attempted, it has not been possible to administer information about parties to be charged. Furthermore, there has been a problem in that has not been possible to specify usage limitations for each of the parties.

### SUMMARY OF THE INVENTION

The present invention has been made in view of the above circumstances.

A first aspect of the present invention includes: a user identification information memory, which stores user identification information for identifying users; an account identification information memory which stores account identification information, which identifies accounts and is associated with the user identification information; a service execution section, which executes a service in accordance with instruction from a user for whom account identification information corresponding to user identification information is present and who is identified by this user identification information, the service being processing relating to document data; and an aggregation section, which aggregates results of services executed by the service execution section for each account of the account identification information.

The present invention is also applied in a second aspect as follows.

That is, in the second aspect of the present invention: on the basis of user identification information for identifying users enabled for usage and account identification information which is associated with the user identification information and identifies accounts, which user identification information and account identification information are stored in a memory, a service, which is processing relating to document data, is executed in accordance with instruction from a user for whom account identification information corresponding to user identification information is present and who is identified by this user identification information; and results of executed services are aggregated for each account of the account identification information.

### BRIEF DESCRIPTION OF THE DRAWINGS

Embodiments of the present invention will be described in detail based on the following figures, wherein:

FIG. 1 is a diagram showing structure of a charging system relating to an embodiment of the present invention.

FIG. 2 is a block diagram of showing structure of a terminal device.

FIG. 3 is a block diagram showing structure of a multifunction device.

FIG. 4 is a diagram describing relationships of information that is stored in a storage section of the multifunction device.

FIG. 5 is a table showing user information and user-aggregated information.

FIG. 6 is a table showing user service usage limitation information and user service functionality limitation information.

FIG. 7 is a table showing account information and account-aggregated information FIG. 8 is a table showing account information, account service usage limitation information, and account service functionality limitation information.

FIG. 9 is a table showing association information.

FIG. 10 is another table showing association information.

FIG. 11 is a chart showing functional structure of elements of the multifunction device.

FIG. 12 is a table showing information in which the user service usage limitation information and the account service usage limitation information are united.

FIG. 13 is a table showing information in which the user service usage limitation information and the account service usage limitation information are united in a different manner.

FIG. 14 is a table showing association information and user service usage limitation information (a limitation on usage of copying).

FIG. 15 is a table showing other association information and account service usage limitation information (limitations on usage of faxing and scanning).

FIG. 16 is a table showing limitation information for user ID “123ABC”.

### DETAILED DESCRIPTION OF THE INVENTION

Below, a embodiment of the present invention will be described in detail with reference to the drawings.

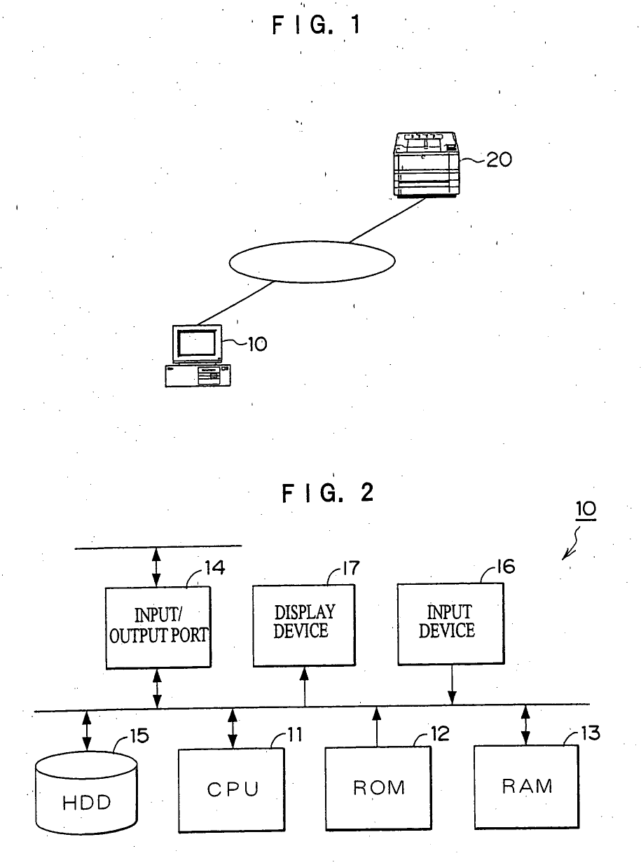

FIG. 1 is a diagram showing structure of a charging system relating to the embodiment of the present invention. The charging system is provided with a terminal device 10 and a multifunction device 20. The terminal device 10 logs in to the multifunction device 20 and instructs execution of desired services. The multifunction device 20 performs various services, such as copying, printing, fax transmission and the like.

Herein, “services” means processes (functions) relating to documents, such as printing, scanning, copying, fax transmission, OCR, e-mail transmission, arrangement in folders, and so forth, but is not especially limited. “Documents” means data relating to texts. A document could be image data, could be text data, could be a document including image data and text data, and is not especially limited.

FIG. 2 is a block diagram showing structure of the terminal device 10. The terminal device 10 is equipped with a CPU 11, a ROM 12, a RAM 13, an input/output port 14, a hard disk drive 15, an input device 16 and a display device 17. The CPU 11 performs predetermined operational processes. The ROM 12 stores a control program for the CPU 11. The RAM 13 is a data work area. The input/output port 14 is for implementing reception and transmission of information through a network. The hard disk drive 15 stores various kinds of information which has been inputted through the input/output port 14. The input device 16 includes a a keyboard and a pointing device or the like. A user ID, an account ID and the like are inputted at the input device 16. The display device 17 displays information during input and the like.

The CPU 11 sends, for example, a user ID and account ID inputted at the input device 16 through the input/output port 14 to the multifunction device 20. The CPU 11 logs in to the multifunction device 20 and subsequently sends instructions for execution of predetermined services to the multifunction device 20. User IDs and account IDs will be discussed later.

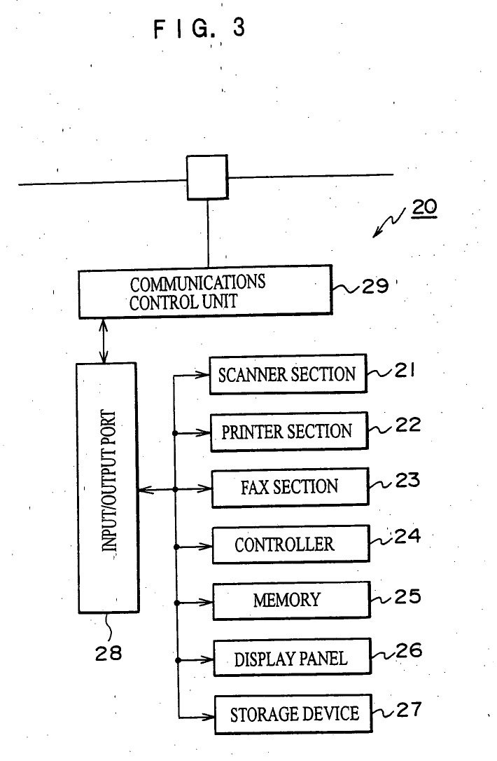

FIG. 3 is a block diagram showing structure of the multifunction device 20. The multifunction device 20 is capable of performing numerous services, such as printing, fax transmission, copying, scanning and so forth. The multifunction device 20 is capable of limiting usage of services and limiting predetermined functions of the services that can be used, for each of users and/or for each of accounts.

The multifunction device 20 is equipped with a scanner section 21, a printer section 22 and a facsimile (hereafter shortened to “fax”) section 23. The scanner section 21 reads in images that have been recorded on originals. The printer section 22 records electrostatic latent images on photosensitive bodies, develops the electrostatic latent images with monochrome toner or color toner, transfers the developed images to recording paper, and outputs the recording paper. The fax section 23 carries out transmission and reception of facsimile documents.

The multifunction device 20 is further equipped with a controller 24, memory 25, a display panel 26, a storage device 27, an input/output port 28 and a communications control unit 29. The controller 24 performs overall control of the multifunction device 20. The memory 25 memorizes image data read in by the scanner section 21, image data received through the network, data of documents received by fax, and so forth. The display panel 26 displays an operation screen including icons and inputs operational information in accordance with touch-operation of the icons. The storage device 27 stores user information and the like. The input/output port 28 is for inputting and outputting data. The communications control unit 29 implements communication with devices which are connected to the network.

The scanner section 21, the printer section 22, the fax section 23, the controller 24, the memory 25, the display panel 26, the storage device 27 and the input/output port 28 are connected to one another by a bus. The input/output port 28 is connected through the communications control unit 29 to the network. Note that the scanner section 21 may be combined with the fax section 23 to form a single section.

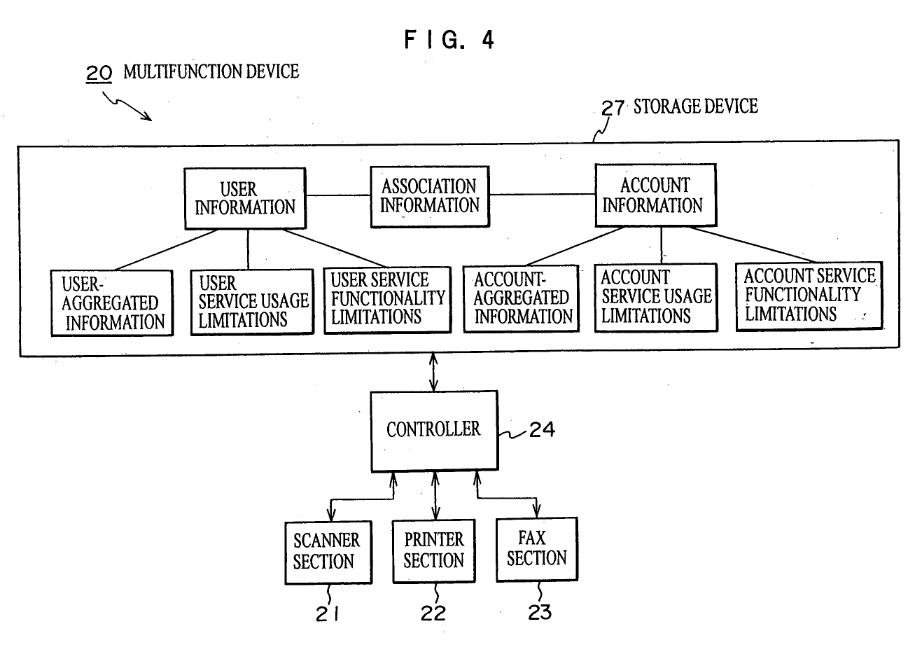

FIG. 4 is a diagram showing functional structure of principal elements of the multifunction device 20. The storage device 27 stores user information, user-aggregated information, user service usage limitation information, user service functionality limitation information, account information, account-aggregated information, account service usage limitation information and account service functionality limitation information. The controller 24 of the multifunction device 20 controls the scanner section 21, the printer section 22 and the fax section 23 in accordance with the various kinds of limitation information stored at the storage device 27.

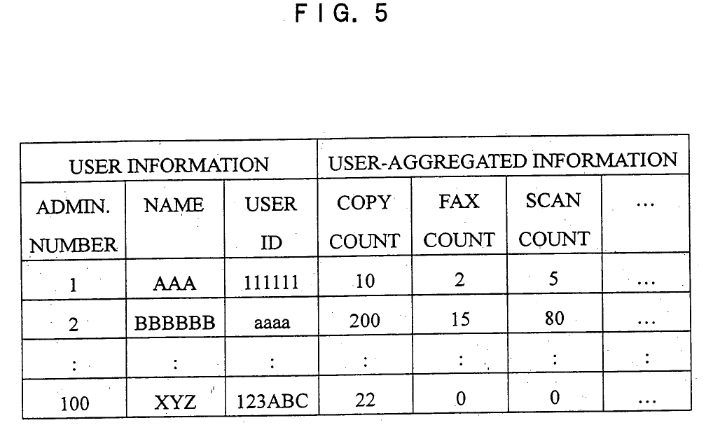

FIG. 5 is a table showing the user information and the user-aggregated information. The user information is constituted by an “administration number”, which is a logical number for administration of users, a “name”, which represents a name of a user, and a “user ID”, which is information for individual identification of users. The user-aggregated information is information which is aggregated for each user, concerning which services have been used and to what extent. The user-aggregated information is constituted by a copy count, a fax count, and a scan count.

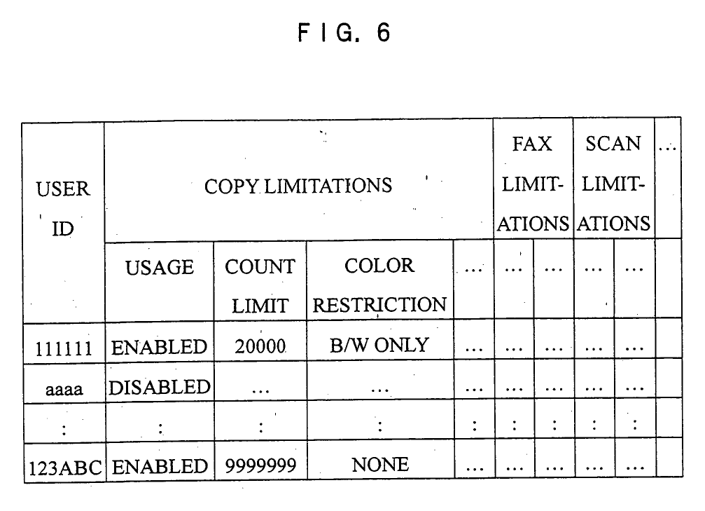

FIG. 6 is a table showing the user service usage limitation information and the user service functionality limitation information. FIG. 6 only shows usage limitations and functionality limitations which relate to copying. For each user, the user service usage limitation information for copying includes “usage”, which represents whether usage of copying is enabled or disabled. Further, for each user, the user service functionality limitation information for copying includes a “count limit”, which represents an upper limit on the copy count, and “color restriction”, which represents whether color copying is enabled, and suchlike. Of course, although not shown here, there are also user service usage limitation information and user service functionality limitation information for services other than copying.

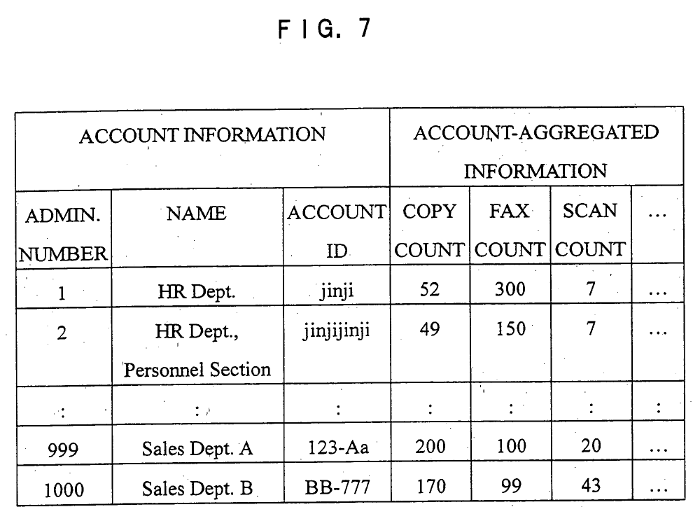

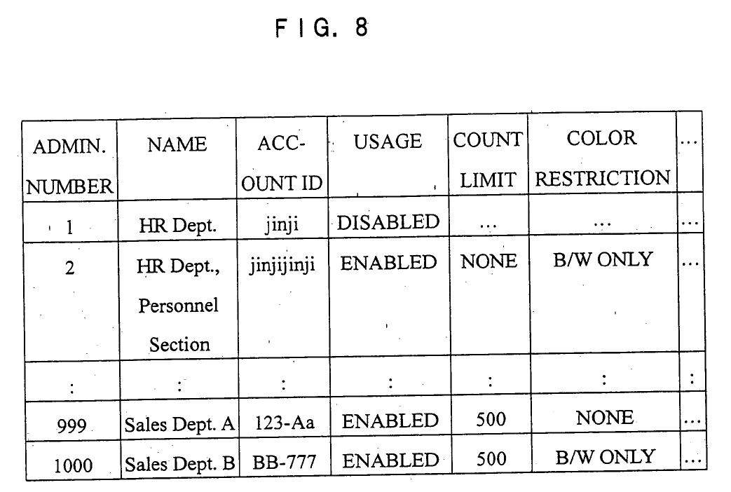

FIG. 7 is a table showing the account information and the account-aggregated information. FIG. 8 is a table showing the account information, the account service usage limitation information and the account service functionality limitation information. FIG. 8 only shows usage limitations and functionality limitations which relate to copying. The account information is information representing a party to be charged, and includes an “administration number”, which is a logical number for administration of accounts, a “name”, which represents a name of the account, and an “account ID”, which is information for individual identification of accounts.

For each account, the account service usage limitation information includes “usage”, which represents whether usage of copying is enabled or disabled. For each account, the account service usage limitation information also includes a “count limit”, which represents an upper limit on the copy count, “color restriction”, which represents whether color copying is enabled, and suchlike. Of course, although not shown here, there are also account service usage limitation information and account service functionality limitation information for services other than copying.

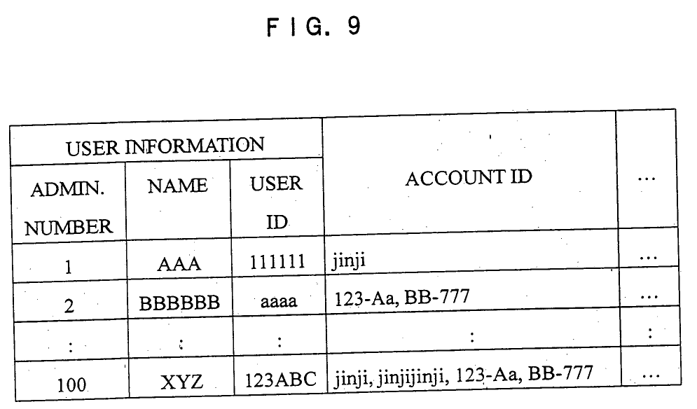

FIG. 9 is a table showing association information. This association information associates one or more account IDs with each user ID. For example, an account for user “AAA”, with the user ID “11111”, has the account ID “jinji”. Further, accounts for user “BBBBBB”, with the user ID “aaaa”, have the account IDs “123-Aa” and “BB-777”. Note that the association information is not limited to such a structure and can be, for example, as follows.

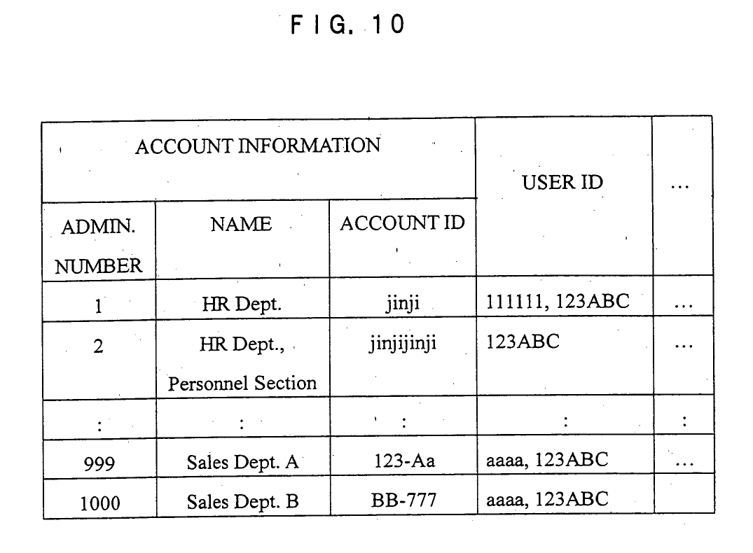

FIG. 10 is another table showing association information. This association information associates one or more user IDs with each account ID. For example, an “HR Dept.” account with the acount ID “jinji” is the account for user IDs “111111” and “123ABC”.

In the charging system that is structured as described above, the multifunction device 20 executes services in accordance with the following sequence.

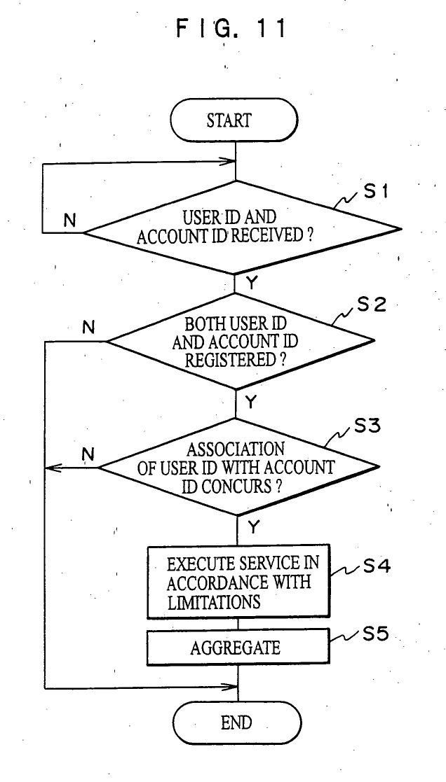

FIG. 11 is a chart showing a processing sequence when the controller 24 of the multifunction device 20 performs a service. Specifically, the controller 24 executes processing from step S1 to step S5.

In step S1, the controller 24 of the multifunction device 20 judges whether or not a user ID and account ID sent from the multifunction device 20 have been received, and waits until reception thereof. Then, when reception is confirmed, the sequence advances to step S2.

In step S2, the controller 24 judges whether or not both of the user ID and the account ID are registered in the storage device 27. If either of the user ID and the account ID is not registered, the controller 24 cannot perform the service, so processing finishes. If the user ID and the account ID are both registered in the storage device 27, the sequence advances to step S3.

In step S3, the controller 24 refers to the association information of FIG. 9 or FIG. 10, and judges whether or not an association of the user ID with the account ID concurs with the association information (i.e., whether the user ID and the account ID are associated). Then, if this association does not concur, there is no account, so processing finishes. If the association does concur, the sequence advances to step S4.

In step S4, a service request from the user (i.e., from the terminal device 10) that is in accordance with the user service usage limitation information, the user service functionality limitation information, the account service usage limitation information and the account service functionality limitation information is accepted, instructions for execution of a service are issued to a service execution section (for example, any of the scanner section 21, the printer section 22 and the fax section 23), and the sequence advances to step S5. Modes of executing services in accordance with the limitation information will be described below.

In step S5, the controller 24 aggregates results of previous executions of services with a result of the current execution of a service for the respective user ID and the respective account ID, and updates the user-aggregated information and the account-aggregated information. Then, processing ends. Hence, users can, for example, check account-aggregated information for respective account IDs by logging in to the multifunction device 20 from the terminal device 10 and accessing the account-aggregated information.

Now, in step S4, service usage limitation information and service functionality limitation information are respectively present for each of the user ID and the account ID. Accordingly, the controller 24 may execute a service in the manner of any of the following first to third modes.

—First Mode—

The controller 24 compares the user service usage limitation information with the account service usage limitation information, and selects only limitations for which the user service usage limitation information matches the account service usage limitation information as effective limitations. That is, a limitation is set to be effective if the limitation satisfies a condition of ANDing the two service usage limitation informations. Hence, the controller 24 may accept service requests from the user that are in accordance with the effective limitations, and execute such services.

Further, when the controller 24 compares the user service usage limitation information with the account service usage limitation information, if the user service usage limitation information and the account service usage limitation information completely match, the controller 24 may create a single combined set of information therefrom and use this information.

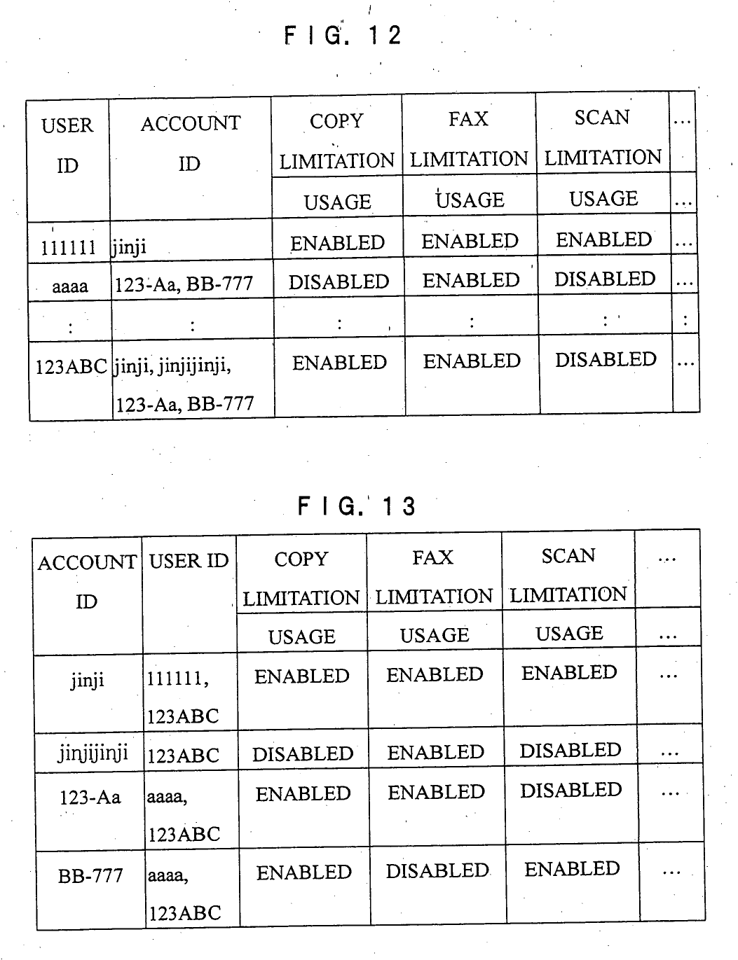

FIG. 12 is a table showing information in which the user service usage limitation information and the account service usage limitation information are united. As shown in FIG. 12, one or more account IDs and usage limitation information (a copying limitation, a faxing limitation and a scanning limitation) are corresponded with each user ID.

FIG. 13 is a table showing information in which the user service usage limitation information and the account service usage limitation information are united in a different manner. As shown in FIG. 13, one or more user IDs and usage limitation information (a copying limitation, a faxing limitation and a scanning limitation) are corresponded with each account ID.

In FIGS. 12 and 13, the user service usage limitation information and the account service usage limitation information are combined into a single set of information. The user service functionality limitation information and the account service functionality limitation information can also be combined into a single set of information.

—Second Mode—

When the user service usage limitation information differs from the account service usage limitation information, the controller 24 may give precedence to association information that corresponds one or more account IDs with a user ID (see FIG. 9).

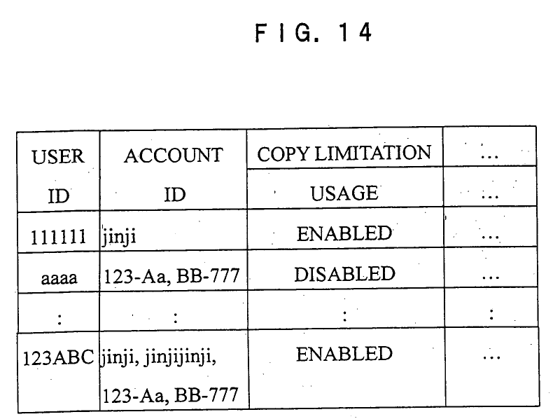

FIG. 14 is a table showing the association information shown in FIG. 9 with user service usage limitation information (here, the limitation on usage of copying). Thus, the controller 24 may execute services that are in accordance with the association information shown in FIG. 9 and the limitations of the user service usage limitation information.

Further, the controller 24 may give precedence to association information which corresponds one or more user IDs with an account ID (see FIG. 10).

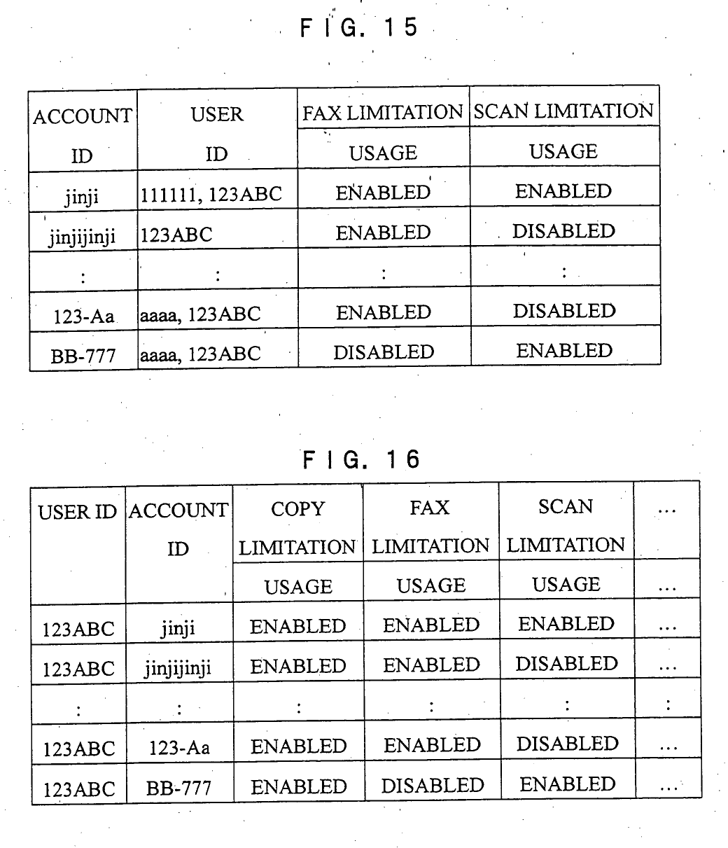

FIG. 15 is a table showing the association information shown in FIG. 10 with account service usage limitation information (here, limitations on usage of faxing and scanning). Thus, the controller 24 may execute services that are in accordance with the association information shown in FIG. 10 and the limitations of the account service usage limitation information.

—Third Aspect—

The controller 24 may combine the association information shown in FIGS. 9 and 10. Specifically, the controller 24 compares the user service usage limitation information with the account service usage limitation information, selects limitations for which the user service usage limitation information and the account service usage limitation information are duplicated and match as effective limitations, and also sets limitations that are not duplicated as effective limitations. A limitation that is not duplicated means a limitation which is set in the service usage limitation information for one of the user and the account but is not set in the other service usage limitation information thereof. In other words, the controller 24 may set a limitation that satisfies a condition of ORing the user service usage limitation information and the account service usage limitation information as an effective limitation. Hence, the controller 24 may execute services that are in accordance with the user information, the account information, the association information shown in FIGS. 9 and 10, and these effective limitations.

For example, in a case with the user service usage limitation information of FIG. 14 and the account service usage limitation information of FIG. 15, limitation information for user ID “123ABC” that satisfies conditions of ORing the user service usage limitation information with the account service usage limitation information is as follows.

FIG. 16 is a table showing limitation information for user ID “123ABC”. For example, when the user ID is “123ABC” and the account ID is “jinji”, copy usage is enabled, fax usage is enabled and scanning usage is enabled. As a further example, when the user ID is “123ABC” and the account ID is “123-Aa”, copy usage is enabled and fax usage is enabled but scanning usage is disabled.

Note that although the first to third modes described above have been explained principally for usage limitation information, functionality limitation information can be dealt with in a similar manner. Furthermore, obviously, usage limitation information and functionality limitation information can be dealt with together.

As described above, the charging system relating to the embodiment of the present invention specifies account IDs representing accounts, and can aggregate and store usage results of services for each account ID. Thus, it is possible to administer information relating to charging with ease. Moreover, because the charging system described above can specify service usage limitations and/or functionality limitations for account IDs as well as for user IDs, it is possible to specify limitations on services in various ways.

Obviously, the present invention is not limited to the embodiment described above, and can be applied to structures with designs which are modified within the scope described in the claims.

For example, the present invention is not limited to a case in which the various kinds of information shown in FIG. 4 are respectively separated, and may have a form in which the various kinds of information are incorporated in arbitrary structures. Further, the present invention is not limited to a case in which all of this information is stored at a single device, and arbitrary information may be stored at other devices (for example, an administration server).

Further again, the user ID and account ID are information which is inputted from the input device 16 of the terminal device 10. However, a user ID and account ID or the like may, for example, be information which is acquired by a card reader from an ID card. In other words, modes of input of user IDs, account IDs and the like are not limited.

Further still, in the embodiment described above, the multifunction device 20 has been described as an example of a service execution device for executing services. However, obviously, the service execution device is not limited as long as it is something which is capable of executing services.

As described above, some embodiments of the invention are outlined below.

The embodiments of the present invention can administer information relating to charges, by executing services which are processes relating to document data in accordance with the presence of account identification information corresponding to user identification information and instructions from a user identified by that user identification information, and aggregating results of executions for each account of the account identification information.

In the embodiment of this invention, the user identification information is stored in the user identification information memory. The user identification information is information for identifying users who can utilize the service execution device. The account identification information is stored in the account identification information memory. The account identification information is information for identifying parties to be charged when users execute services. The user identification information and the account identification information are associated with each other. Accordingly, a set of account identification information may be corresponded with one or more sets of user identification information, and a set of user identification information may be corresponded with more than one or more sets of account identification information.

The service execution section executes services, which is to say processes relating to document data. The services are not particularly limited, as long as they are processes relating to document data. For example, output processes such as printing, faxing, e-mail transmission and the like, image processes such as removing noise from image data, OCR processing and the like, and so forth would be applicable. The services that the service execution section executes are subject to charges. Accordingly, only users for whom account identification information corresponding to user identification information of the user is present and who are identified by that user identification information can instruct the service execution section to execute services. Further, the aggregation section aggregates the results of executions by the service execution section for each set of account identification information.

What is claimed is:

1. A service execution device comprising:
a user identification information memory, which stores user identification information for identifying users;
an account identification information memory which stores account identification information, which is associated with the user identification information and identifies accounts;
a service execution section, which executes a service in accordance with instruction from a user for whom account identification information corresponding to user identification information is present and who is identified by this user identification information, the service including processing relating to document data; and
an aggregation section, which aggregates results of services executed by the service execution section for each account of the account identification information.

2. The service execution device of claim 1, wherein, for each account of the account identification information, the account identification information memory stores at least one of service usage limitation information, which represents at least one of services which are usage-enabled and services which are usage-disabled, and service function limitation information, which represents, for services that are usage-enabled, at least one of functions which are limited and functions which are not limited, and
the service execution section executes the service in accordance with the at least one of the service usage limitation information and the service function limitation information stored in the account identification information memory.

3. The service execution device of claim 2, wherein, for each user of the user identification information, the user identification information memory stores at least one of service usage limitation information, which represents at least one of services which are usage-enabled and services which are usage-disabled, and service function limitation information, which represents, for services that are usage-enabled, at least one of functions which are limited and functions which are not limited, and
the service execution section executes the service in accordance with the at least one of the service usage limitation information and the service function limitation information stored in the user identification information memory.

4. The service execution device of claim 3, wherein, from the service usage limitation information and service function limitation information stored in the account identification information memory and the service usage limitation information and service function limitation information stored in the user identification information memory, the service execution section selects limitation information that is duplicated as first effective limitation information, and executes the service in accordance with the first effective limitation information.

5. The service execution device of claim 4, wherein, from the service usage limitation information and service function limitation information stored in the account identification information memory and the service usage limitation information and service function limitation information stored in the user identification information memory, the service execution section selects limitation information that is not duplicated as second effective limitation information, and executes the service in accordance with the first and second effective limitation information.

6. A service execution method comprising:
on the basis of user identification information for identifying users enabled for usage and account identification information which is associated with the user identification information and identifies accounts, which user identification information and account identification information are stored in a memory, executing a service, which includes processing relating to document data, in accordance with instruction from a user for whom account identification information corresponding to user identification information is present and who is identified by this user identification information, and
aggregating results of executed services for each account of the account identification information.

7. The service execution device of claim 6, wherein, for each account of the account identification information, at least one of service usage limitation information, which represents at least one of services which are usage-enabled and services which are usage-disabled, and service function limitation information, which represents, for services that are usage-enabled, at least one of functions which are limited and functions which are not limited, is stored in the memory, and
the service is executed in accordance with the at least one of the service usage limitation information and the service function limitation information that is stored in the memory.

8. The service execution device of claim 7, wherein, for each user of the user identification information, at least one of service usage limitation information, which represents at least one of services which are usage-enabled and services which are usage-disabled, and service function limitation information, which represents, for services that are usage-enabled, at least one of functions which are limited and functions which are not limited, is stored in the memory, and
the service is executed in accordance with the at least one of the service usage limitation information and the service function limitation information that is stored in the memory.

9. The service execution device of claim 8, wherein limitation information that is duplicated in the service usage limitation information and service function limitation information stored in the memory is selected as first effective limitation information, and the service is executed in accordance with the first effective limitation information.

10. The service execution device of claim 9, wherein limitation information that is not duplicated in the service usage limitation information and service function limitation information stored in the memory is selected as second effective limitation information, and the service is executed in accordance with the first and second effective limitation information.

11. A charging system comprising
a terminal device and
a service execution device which includes:
a user identification information memory, which stores user identification information for identifying users;
an account identification information memory which stores account identification information, which is associated with the user identification information and identifies accounts;
a service execution section, which executes a service in accordance with instruction from a user for whom account identification information corresponding to user identification information which has been inputted from the terminal device is present and who is identified by this user identification information, the service including processing relating to document data; and
an aggregation section, which aggregates results of services executed by the service execution section for each account of the account identification information.

12. The charging system of claim 11, wherein, for each account of the account identification information, the account identification information memory stores at least one of service usage limitation information, which represents at least one of services which are usage-enabled and services which are usage-disabled, and service function limitation information, which represents, for services that are usage-enabled, at least one of functions which are limited and functions which are not limited, and
the service execution section executes the service in accordance with the at least one of the service usage limitation information and the service function limitation information stored in the account identification information memory.

13. The charging system of claim 12, wherein, for each user of the user identification information, the user identification information memory stores at least one of service usage limitation information, which represents at least one of services which are usage-enabled and services which are usage-disabled, and service function limitation information, which represents, for services that are usage-enabled, at least one of functions which are limited and functions which are not limited, and
the service execution section executes the service in accordance with the at least one of the service usage limitation information and the service function limitation information stored in the user identification information memory.

14. The charging system of claim 13, wherein, from the service usage limitation information and service function limitation information stored in the account identification information memory and the service usage limitation information and service function limitation information stored in the user identification information memory, the service execution section selects limitation information that is duplicated as first effective limitation information, and executes the service in accordance with the first effective limitation information.

15. The charging system of claim 14, wherein, from the service usage limitation information and service function limitation information stored in the account identification information memory and the service usage limitation information and service function limitation information stored in the user identification information memory, the service execution section selects limitation information that is not duplicated as second effective limitation information, and executes the service in accordance with the first and second effective limitation information.
